(19) United States
(12) Patent Application Publication
(10) Pub. No.: US 2024/0188152 A1
(43) Pub. Date: Jun. 6, 2024

(54) SYSTEMS AND METHODS FOR ESTABLISHING SHARED N3 TUNNEL

(71) Applicant: ZTE CORPORATION, Shenzhen (CN)

(72) Inventors: Yansheng LIU, Shenzhen (CN); Zijiang MA, Shenzhen (CN); Dapeng LI, Shenzhen (CN)

(73) Assignee: ZTE CORPORATION, Shenzhen (CN)

(21) Appl. No.: 18/517,605

(22) Filed: Nov. 22, 2023

Related U.S. Application Data
(63) Continuation of application No. PCT/CN2021/112237, filed on Aug. 12, 2021.

(51) Int. Cl. H04W 76/12; H04L 5/00; H04W 76/30; H04W 76/40

(52) U.S. Cl. CPC H04W 76/12; H04L 5/0053; H04W 76/30; H04W 76/40

(57) ABSTRACT

Embodiments of a system, device and method for establishing a shared N3 tunnel are disclosed. In some aspects, a wireless communication method includes establishing, by a first one of a plurality of wireless communication nodes, a tunnel based on at least one of: (i) whether a context of a Multicast and Broadcast Services (MBS) session is received, or (ii) one or more acknowledgement (ACK) messages corresponding to the context and the tunnel are received, the tunnel being shared by the plurality of wireless communication nodes for accessing a core network. In some embodiments, the plurality of wireless communication nodes share a same Centralized Unit-User Plane (CU-UP).

### CROSS-REFERENCE TO RELATED APPLICATION

This application claims the benefit of priority under 35 U.S.C. § 120 as a continuation of International Patent Application No. PCT/CN2021/112237, filed on Aug. 12, 2021, the disclosure of which is incorporated herein by reference in its entirety.

### TECHNICAL FIELD

The disclosure relates generally to wireless communications and, more particularly, to systems and methods for establishing a shared N3 tunnel.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

Embodiments of a system, device and method for establishing a shared N3 tunnel are disclosed. In some aspects, a wireless communication method includes establishing, by a first one of a plurality of wireless communication nodes, a tunnel based on at least one of (i) whether a context of a Multicast and Broadcast Services (MBS) session is received, or (ii) one or more acknowledgement (ACK) messages corresponding to the context and the tunnel are received, the tunnel being shared by the plurality of wireless communication nodes for accessing a core network. In some embodiments, the plurality of wireless communication nodes share a same Centralized Unit-User Plane (CU-UP).

In some aspects, the first wireless communication node is pre-configured as an anchor node, the method further includes storing, by the first wireless communication node, the context, and generating, by the first wireless communication node, a User Equipment (UE) list and an Random Access Node Identification (RAN ID) list associated with the context and the tunnel.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIGS. 3A-3B illustrate block diagrams of a network structure, in accordance with some embodiments.

FIG. 4 illustrates a swim lane diagram for a pre-configured Anchor Node triggering Shared N3 Tunnel establishment, in accordance with some embodiments.

FIG. 5 illustrates a swim lane diagram for the pre-configured Anchor Node transmitting MBS and tunnel info to the Other Nodes with a known area ID, in accordance with some embodiments.

FIG. 6 illustrates a swim lane diagram for the pre-configured Anchor Node transmits iMBS and tunnel info to the Other Nodes without a known area ID, in accordance with some embodiments.

FIG. 7 illustrates a swim lane diagram for the Other Node establishing the Shared N3 Tunnel for the case of a pre-configured Anchor Node, in accordance with some embodiments.

FIG. 8 illustrates a swim lane diagram for the RAN Node establishing the Shared N3 Tunnel with a known area ID, for the case of a contention-based Anchor Node, in accordance with some embodiments.

FIG. 9 illustrates a swim lane diagram for the RAN Node establishing the Shared N3 Tunnel without a known area ID, for the case of a contention-based Anchor Node, in accordance with some embodiments.

FIG. 10 illustrates a swim lane diagram for anchor node contention, in accordance with some embodiments.

FIG. 11 illustrates a swim lane diagram for the Other Node re-using shared N3 Tunnel, in accordance with some embodiments.

FIG. 12 illustrates a swim lane diagram for the Other Node releasing the shared N3 Tunnel, in accordance with some embodiments.

FIG. 13 illustrates a swim lane diagram for the Anchor Node releasing shared N3 Tunnel, in accordance with some embodiments.

FIG. 14 illustrates a swim lane diagram for performing an Intra-Union RAN Handover, in accordance with some embodiments.

FIG. 15 illustrates a swim lane diagram for performing an Inter-Union RAN Handover, in accordance with some embodiments.

FIG. 16 illustrates a swim lane diagram for performing E1AP Procedure for re-using Shared N3 Tunnel, in accordance with some embodiments.

FIG. 17 illustrates a method 1700 of establishing a tunnel, in accordance with some embodiments.

### DETAILED DESCRIPTION OF EXAMPLE EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

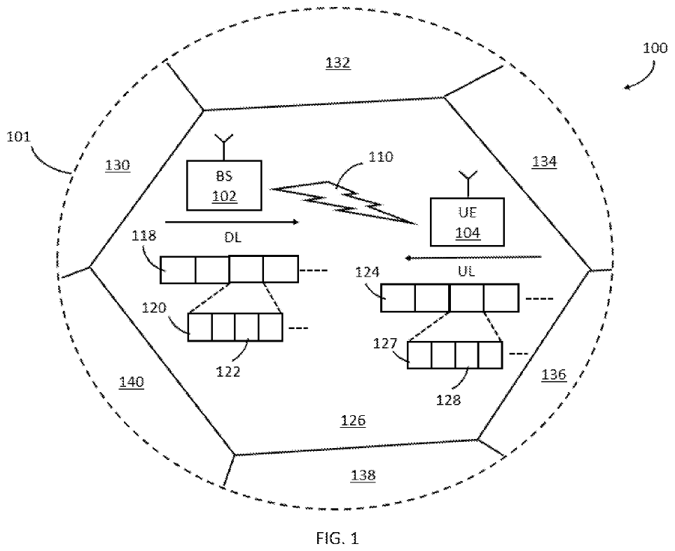

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

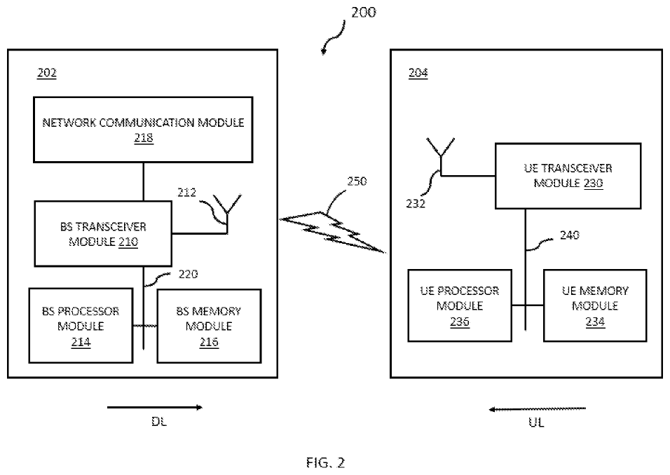

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Establishing a Shared N3 Tunnel

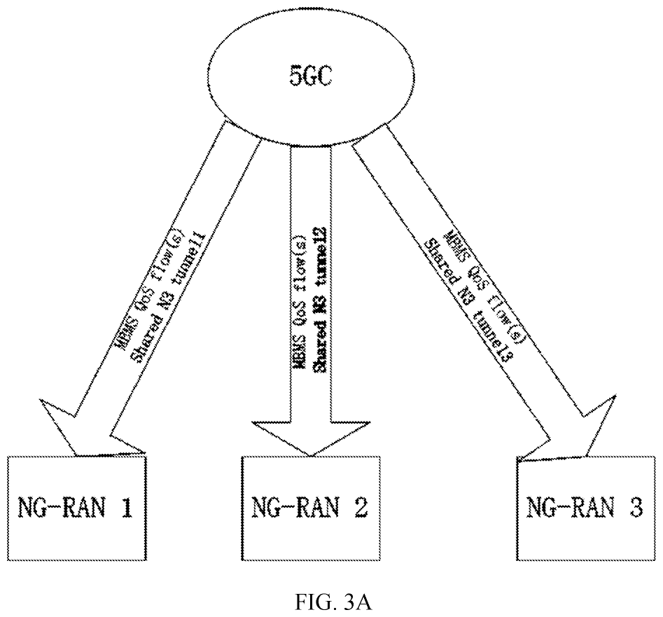

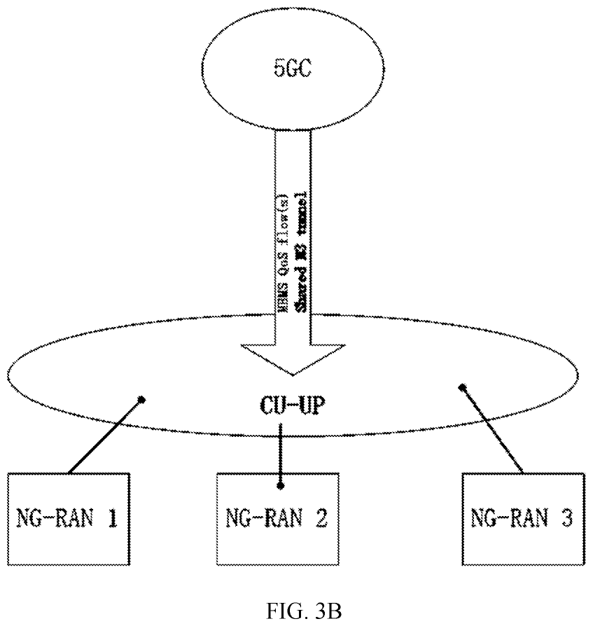

FIGS. 3A-3B illustrate network structures, in accordance with some embodiments. A common network structure is shown in in FIG. 3A. Different Next Generation Random Access Network (NG-RAN) nodes do not share Centralized Unit-User Plane (CU-UP) with others. For a special network structure which is shown in FIG. 3B, one CU-UP can be used by multiple NG-RAN nodes. Hence, it is possible that one shared N3 tunnel for Multicast and Broadcast Services (MBS) data transmission can be used by all involved NG-RAN nodes in this special case. However, no mechanism is defined to let the NG-RAN nodes which share the same CU-UP know whether the shared N3 tunnel for a MBS session has been established in the shared CU-UP. Disclosed herein are embodiments of a mechanism to solve this technical problem.

In some embodiments, in normal 5G network deployment (FIG. 3A), for a certain Multimedia Broadcast/Multicast Service (MBMS, also known as Multicast and Broadcast Services (MBS)) service including one or MBMS Quality of Service (QoS) flow, User Plane Function (UPF), which is one of the 5G core network (5GC) entities, establishes one N3 tunnel with each NG-RAN node. In some embodiments, a RAN node (e.g., a NG-RAN node) covers a geographical area which is divided into cell areas, with each cell area being served by a base station (BS, e.g., the BS 102, the BS 202, a next generation NodeB (gNB), an evolved NodeB (eNB), a wireless communication node, a cell tower, a 3GPP radio access device, a non-3GPP radio access device, etc.). In some embodiments, a user equipment (UE, e.g., the UE 104, the UE 204, a mobile device, a wireless communication device, a terminal, etc.) camps on a cell belonged to one NG-RAN, when network allows the UE to join an MBMS service including one or more MBMS QoS flows. In the NG-RAN node, if the MBMS service is always established, e.g., the multicast/shared N3 tunnel (used to transmit the user data of the MBMS service) is already established, 5GC does not need to re-establish the shared N3 tunnel for this UE. But, in some embodiments, if MBMS service is not established, e.g., the multicast/shared N3 tunnel is not established, then the 5GC establishes the multicast/shared tunnel between the 5GC and the NG-RAN to transmit MBMS user data from the UPF to the NG-RAN.

In a special 5G network deployment (FIG. 3B), some NG-RAN nodes share the union user plane resources (e.g., a common user plane resource pool), and only one N3 tunnel is needed between UPF and some NG-RAN nodes. If the 5GC has acknowledged that the multicast/shared N3 tunnel for a certain MBMS service has already been established in a certain NG-RAN node, e.g., NG-RAN1 or NG-RAN node 1, and a neighboring NG-RAN node, e.g., NG-RAN2 or NG-RAN node 2, has the union user plane resource pool with NG-RAN1, then the 5GC does not need to re-establish the shared N3 tunnel.

Currently, for the established multicast/shared N3 tunnel in between UPF and NG-RAN node 1, the 5GC has no idea whether its neighbor NG-RAN node(s) can share the union user plane resource pool with the NG-RAN node 1, so that the 5GC has to establish another shared N3 tunnel for the same MBMS service in the neighbor NG-RAN node(s).

In this current case, when a UE moves from NG-RAN node 1 to its neighbor NG-RAN node, the UE has to receive MBMS user data from the shared N3 tunnel 1 to another shared N3 tunnel (e.g., tunnel 2). What is needed are embodiments of a mechanism to determine whether the neighbor NG-RAN node(s) can share the union user plane resource pool with the NG-RAN node 1.

Some embodiments of an Xn Application Protocol (Xn-AP) enhancement are introduced to solve the MBS shared N3 tunnel establishment, release, and UE handover for the shared CU-UP case. In addition, some embodiments, of an E1 Application Protocol (E1AP) are introduced.

In some embodiments, a Union RAN is a RAN node group which shares the same CU-UP, as shown in FIG. 3B. In some embodiments, an Anchor Node is a pre-configured master node in the Union RAN. In some embodiments, the Anchor Node, controls the final decision about the Union RAN's shared N3 tunnel establishment, release, and UE handover related procedures. In some embodiments, the Union RAN only has one Anchor Node. In some embodiments, all RAN Nodes in the Union RAN know which Node is the Anchor Node. In some embodiments, the remaining/rest of the RAN nodes in the Union RAN are defined as Other Nodes, with each referred to as Other Node. In some embodiments, the Other Node does not have authority to process the Shared N3 Tunnel for the Union RAN.

All RAN nodes in the Union RAN are not forced to use/re-use the Union RAN's shared N3 tunnel. A RAN node in the Union RAN can also use the common procedure to establish a shared N3 tunnel for itself if necessary.

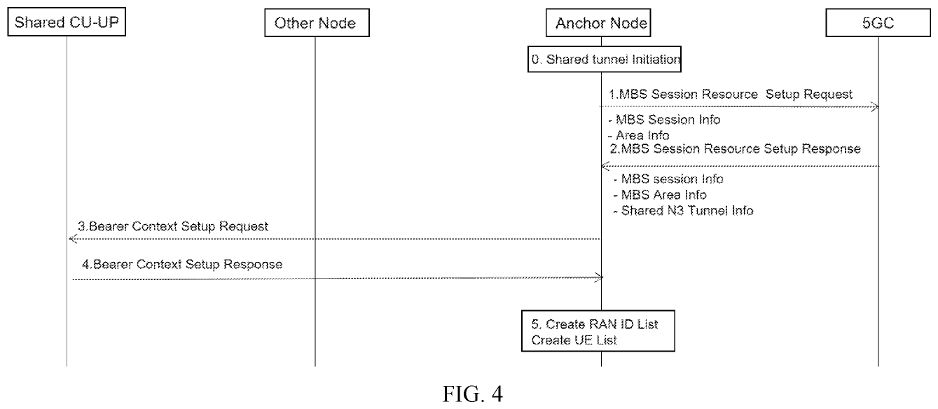

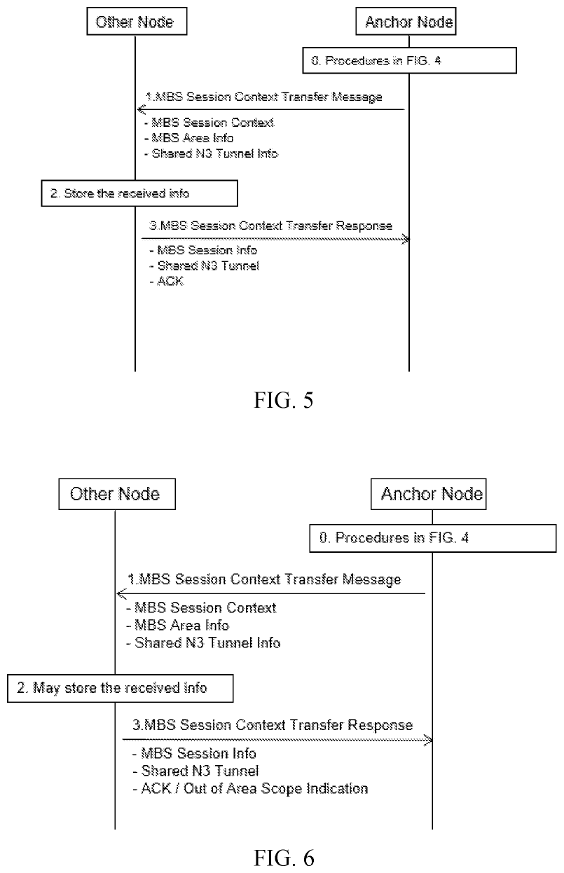

FIG. 4 illustrates a swim lane diagram for a pre-configured Anchor Node triggering Shared N3 Tunnel establishment, in accordance with some embodiments. A shown in FIG. 4, before step 0, a RAN node in the Union RAN is not forced to establish the Shared N3 Tunnel for the Union RAN. The RAN node can also use the common MBS Session Resource Setup procedure to apply a common Shared N3 Tunnel for itself only. At step 0, Anchor Node decides/determines to trigger the shared N3 tunnel establishment. In some embodiments, this procedure can be initiated by either the Anchor Node or an Other Node in the same Union RAN.

At step 1, the Anchor Node sends a Next Generation (NG) message to the 5GC for shared N3 tunnel establishment. The message may contain one or more of MBS Session Info or Area Info (e.g., RAN Node identifier/identification (ID), cell Info, etc.). In some embodiments, the RAN Node ID in Area Info belongs to the RAN Node that initiates the establishment procedure. The RAN Node ID may be either the Anchor Node ID or Other Node ID. At step 2, the 5GC replies with a second NG message to the Anchor node. The message may contain at least one of IBS Session Info, Area Info, or Shared N3 Tunnel Info.

In some embodiments, at step 3, the Anchor Node (CU-CP) transmits the E1 message Bearer Context Setup Request to a Shared CU-UP. In some embodiments, the message at least contains the Shared N3 Tunnel info and the MBS Session Info. In some embodiments, at step 4, the Shared CU-UP replies with the E1 message Bearer Context Setup Response and notices that Shared N3 Tunnel is established successfully/failed (e.g., the Shared N3 Tunnel is established successfully). Note, step 3 and step 4 are not always required for some network structures.

At step 5, the Anchor Node stores the MBS Session Context and creates lists associated with the MBS Session Context and the Shared N3 Tunnel. In some embodiments, the lists include a UE list and a RAN ID list. In some embodiments, the UE List is used to store which UE is currently using the MBS and shared N3 tunnel and camping in the RAN Node. In some embodiments, the RAN ID List is used to store the ID of the RAN Node which is using the MBS and the Shared N3 Tunnel.

FIG. 5 illustrates a swim lane diagram for the pre-configured Anchor Node transmitting MBS and tunnel info to the Other Nodes with a known area ID, in accordance with some embodiments. Before step 0, the Anchor Node knows the area ID of the Other Nodes in the Union RAN. At step 0, the Anchor Node establishes a shared N3 tunnel for the Union RAN and knows the area scope of the current Shared N3 Tunnel for the MBS session (see FIG. 4 for details).

At step 1, the Anchor Node transmits an Xn message (e.g., an MBS Session Context Transfer) to all of the Other Nodes which satisfy/are included/located in the area scope of the Shared N3 Tunnel for the MBS session in the Union RAN. The message may contain one or more of the MBS Session Context, the MBS Area Info (e.g., a list of RAN nodes, a list of cells), or the Shared N3 Tunnel Info. At step 2, all of the Other Nodes store the received info from the Anchor Node.

At step 3, the Other Nodes send a message that is a reply to the Xn message (e.g., MBS Session Context Transfer Response) to the Anchor node. The message may contain one or more of the MBS Session Info, the Shared N3 Tunnel Info, or an Acknowledge indication.

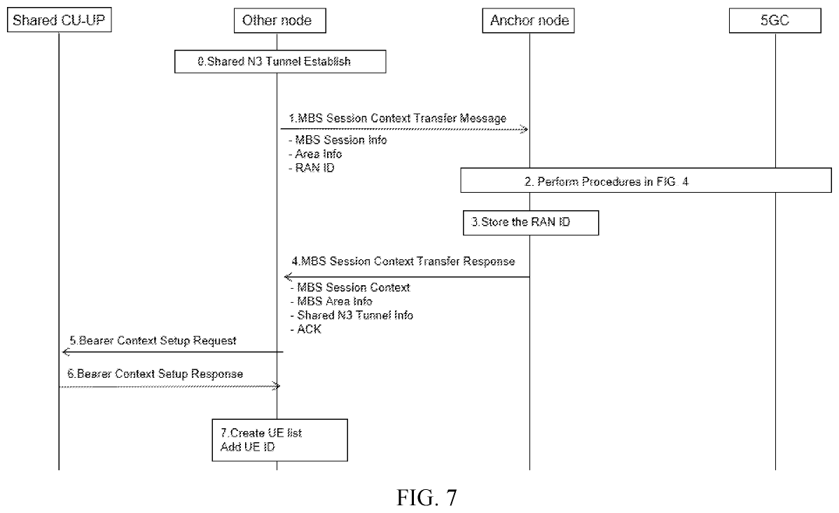

FIG. 6 illustrates a swim lane diagram for the pre-configured Anchor Node transmits MBS and tunnel info to the Other Nodes without a known area ID, in accordance with some embodiments. Before step 0, the Anchor Node does not know the area ID of the Other Nodes in the Union RAN. At step 0, the Anchor Node establishes a shared N3 tunnel for the Union RAN and has known the area scope of the current Shared N3 Tunnel for this MBS session (see FIG. 4 for details).

At step 1, the Anchor Node transmits an Xn message (e.g., an MBS Session Context Transfer) to all of the Other Nodes which are included in the area scope of the Shared N3 Tunnel for the MBS session in the Union RAN. The message may contain one or more of the MBS Session Context, the MBS Area Info (e.g., a list of RAN nodes, a list of cells), or the Shared N3 Tunnel Info. At step 2, The Other Nodes that satisfy/fulfill/meet the received MBS and Shared N3 Tunnel Area requirement store the received info from the Anchor Node. In some embodiments, if one of the Other Nodes does not satisfy the received MBS Area Info, the one of the Other Nodes should not store the received info.

At step 3, the Other Nodes that are included in the area scope and store the received message send a message that is a reply to the Xn message (e.g., MBS Session Context Transfer Response) to the Anchor node. The message may contain one or more of the MBS Session Info, the Shared N3 Tunnel Info, or an Acknowledge indication.

Other Nodes that are not included in the area scope send a message that is a reply an Xn message (e.g., MBS Session Context Transfer Response) to the Anchor node. The message may contain one or more of the MBS Session Info, the Shared N3 Tunnel Info, or an Out of Area Scope Indication.

FIG. 7 illustrates a swim lane diagram for the Other Node establishing the Shared N3 Tunnel for the case of a pre-configured Anchor Node, in accordance with some embodiments. Before step 0, the Other Node does not detect an existing Shared N3 Tunnel for the MBS in the Union RAN. The RAN node in the Union RAN is not forced to establish the Shared N3 Tunnel for the Union RAN. It can also use the common MBS Session Resource Setup procedure to apply a common Shared N3 Tunnel for itself only.

At step 0, the Other Node decides to trigger the Shared N3 Tunnel establishment for an MBS in the Union RAN. At step 1, the Other Node sends an Xn message (e.g., MBS Session Context Transfer) to the Anchor node. The message may contain one or more of IBS Session Info, Area Info (e.g., RAN Node identifier/identification (ID), cell Info, etc.), or the Other Node's RAN ID.

At step 2, after Anchor Node receives the message, the Anchor Node uses the received information to trigger the Shared N3 Tunnel establishment procedure (see FIG. 4 for details). At step 3, the Anchor Node stores the received RAN Node ID into its RAN ID List which indicates that the Other Node is currently using the Shared N3 Tunnel.

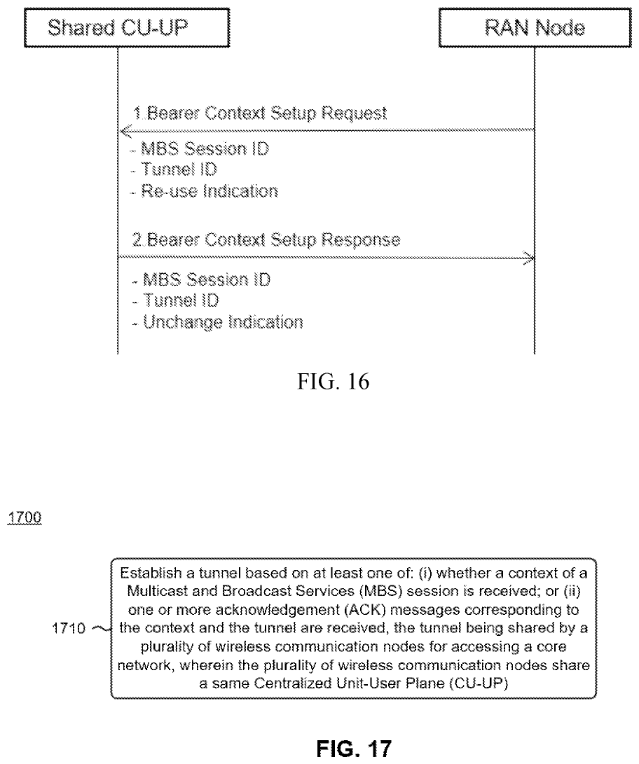

At step 4, the Anchor Node replies with a second Xn message (e.g., MBS Session Context Transfer Response) to the Other Node. The message may contain one or more of the MBS Session Info, the Shared N3 Tunnel Info, or an ACK (Acknowledge) indication. In some embodiments, additional steps (steps 5 and 6) are included, which are discussed with respect to FIG. 16.

At step 7, the Other node creates a UE List associated with the MBS Session Context and Shared N3 Tunnel that is used to record which UE is using the current Shared N3 Tunnel. The ID of the UE that triggers the Shared N3 Tunnel establishment is recorded in the UE List.

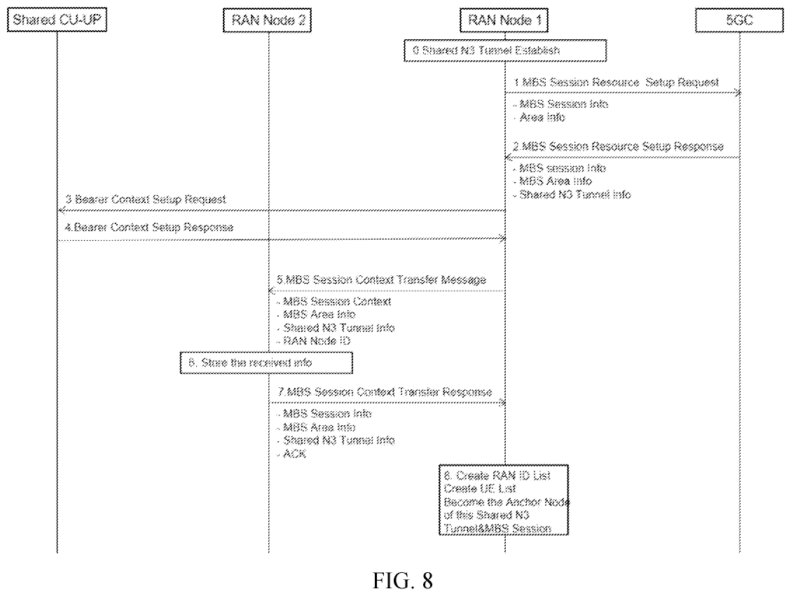

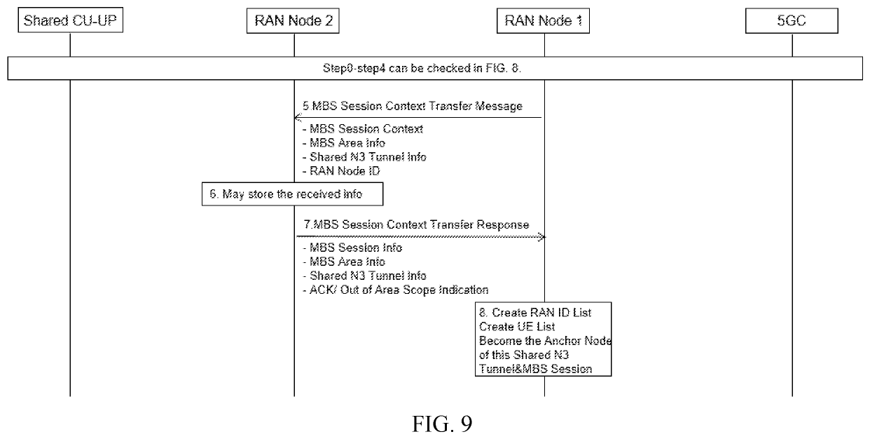

FIG. 8 illustrates a swim lane diagram for the RAN Node establishing the Shared N3 Tunnel with a known area ID, for the case of a contention-based Anchor Node, in accordance with some embodiments. In some embodiments, for a contention-based Anchor Node mechanism, there is no pre-configured/certain anchor node for an Union RAN. In some embodiments, the RAN Node that establishes a shared N3 tunnel for a MBS Session and receives all ACK about the MBS session and the shared N3 tunnel Info from other RAN nodes in the Union RAN is the anchor node of the shared N3 Tunnel and the MBS Session.

Based on the MBS mechanism, an MBS session may transmit different data in different areas (e.g., different RAN nodes or cells). Hence, one MBS Session may need different shared N3 tunnels for different data transmission in the shared CU-UP case. It is possible that there are two or more anchor nodes which control two or more shared N3 tunnels for one MBS session in one Union RAN.

Before step 0, there is no available shared N3 tunnel for MBS session in the Union RAN. At step 0, the RAN Node decides to establish a Shared N3 Tunnel for the Union RAN instead of establishing a common shared N3 tunnel for itself. At step 1, the RAN Node (e.g., RAN Node 1) sends a NG message (e.g., MBS Session Resource Setup Request) to 5GC for shared N3 tunnel establishment. The message may contain one or more of IBS Session Info or Area Info (e.g., RAN Node ID, cell Info, etc.). At step 2, the 5GC replies with a second NG message (e.g., MBS Session Resource Setup Response) to the RAN Node. The message may contain one or more of the MBS Session Info, the MBS Area info (e.g., a list of RAN nodes, a list of cells, etc.), or the Shared N3 Tunnel Info.

In some embodiments, at step 3, The Anchor Node (CU-CP) transmits an E1 message Bearer Context Setup Request to the Shared CU-UP. In some embodiments, the message at least contains the Shared N3 Tunnel info and the MBS Session Info. In some embodiments, at step 4, Shared CU-UP replies with the E1 message Bearer Context Setup Response and notices that Shared N3 Tunnel is established successfully/failed (e.g., the Shared N3 Tunnel is established successfully). Step 3 and step 4 are not always required for some network structures.

At step 5, the RAN Node 1 transmits a Xn message (e.g., MBS Session Context Transfer) to all of the other RAN nodes (e.g., RAN Node 2) which satisfies the received IBS area requirement in this Union RAN. The message may contain one or more of the MBS Session Context, the IBS Area Info (e.g., a list of RAN nodes, a list of cells), the Shared N3 Tunnel Info, or the RAN Node ID. At step 6, all of the other RAN Nodes (e.g., RAN Node 2) store the received info from RAN Node 1.

At step 7, Other RAN nodes (e.g., RAN Node 2) send a message that is a reply to an Xn message (e.g., MBS Session Context Transfer Response) to the RAN Node 1. The message may contain one or more of the MBS Session Info, the Shared N3 Tunnel, or the Acknowledge indication.

At step 8, after RAN Node 1 receives all ACK message from all involved RAN Nodes in the Union RAN, RAN Node 1 becomes the Anchor Node of the shared N3 tunnel associated with the MBS Session in the Union RAN. In some embodiments, RAN Node 1 stores the MBS Session Context and creates lists associated with the MBS Session Context and the Shared N3 Tunnel. In some embodiments, the lists include a UE list and a RAN ID list. In some embodiments, the UE List is used to store which UE is currently using the MBS and shared N3 tunnel and camping in the RAN Node. In some embodiments, the RAN ID List is used to store the ID of the RAN Node which is using the MBS and the Shared N3 Tunnel.

FIG. 9 illustrates a swim lane diagram for the RAN Node establishing the Shared N3 Tunnel without a known area ID, for the case of a contention-based Anchor Node, in accordance with some embodiments. Before step 0, There is no existing shared N3 tunnel for this RAN Node in the Union RAN. Step 0 to Step 4 are as same as in FIG. 8.

At step 5, the RAN Node 1 transmits a Xn message (e.g., MBS Session Context Transfer) to all of the other RAN nodes (e.g., RAN Node 2) in the Union RAN. The message may contain one or more of the MBS Session Context, the MBS Area Info (e.g., a list of RAN nodes, a list of cells), the Shared N3 Tunnel Info, or the RAN Node ID. At step 6, other RAN nodes that satisfy the received MBS Area Info (e.g., RAN Node 2) store the received info from RAN Node 1. If the Other Node does not satisfy the received MBS Area Info, the Other Node should not store the received info.

At step 7, other RAN nodes that are included in the area scope and store the received message (e.g., RAN Node 2) send a message that is a reply to an Xn message (e.g., MBS Session Context Transfer Response) to the RAN Node 1. The message may contain one or more of the MBS Session Info, the Shared N3 Tunnel, or the Acknowledge indication. Other RAN nodes which are not included in the area scope send a message that is a reply to an Xn message (e.g., MBS Session Context Transfer Response) to the Anchor node. The message may contain one or more of the MBS Session Info, the Shared N3 Tunnel, or an Out of Area Scope Indication.

At step 8, after RAN Node 1 receives all replied messages, RAN Node 1 becomes the Anchor Node of the shared N3 tunnel associated with the MBS Session in the Union RAN. In some embodiments, RAN Node 1 stores the MBS Session Context and creates lists associated with the MBS Session Context and the Shared N3 Tunnel. In some embodiments, the lists include a UE list and a RAN ID list. In some embodiments, the UE List is used to store which UE is currently using the MBS and shared N3 tunnel and camping in the RAN Node. In some embodiments, the RAN ID List is used to store the ID of the RAN Node which is using the MBS and the Shared N3 Tunnel.

### Embodiment 7) (Contention Based Anchor Node) Anchor Node Contention

Considering all RAN nodes in the Union RAN are possible to be the Anchor Node for a shared N3 tunnel associated with a MBS session, it is possible that two RAN nodes in an Union RAN trigger the shared N3 tunnel establishment simultaneously. A default priority is introduced to solve the anchor node contention. In some embodiments of the contention situation, the RAN Node with higher priority is the Anchor Node. Lower priority Node should release its MBS Session info and related shared N3 Tunnel. Other Nodes should only stores the info received from the higher priority node (Anchor Node).

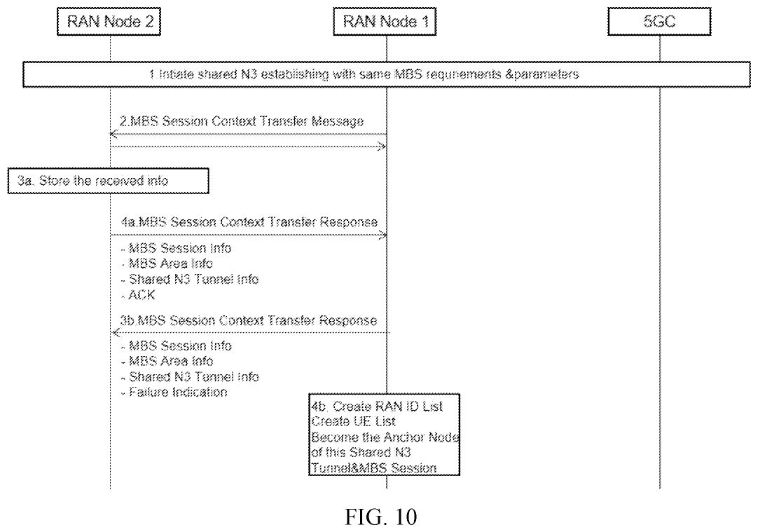

FIG. 10 illustrates a swim lane diagram for anchor node contention, in accordance with some embodiments. Given that any of the RAN nodes in the Union RAN can be the Anchor Node for a shared N3 tunnel associated with a MBS session, it is possible that two RAN nodes in an Union RAN trigger the shared N3 tunnel establishment simultaneously. In some embodiments, a default priority resolves the anchor node contention. In the contention situation, in some embodiments, the RAN Node with the higher priority is the Anchor Node. In some embodiments, the RAN Node with a lower priority (e.g., Lower priority Node) releases its MBS Session info and related shared N3 Tunnel. In some embodiments, Other Nodes only store the info received from the higher priority node (e.g., Anchor Node). In some embodiments such as that depicted in FIG. 10, RAN Node 1 has higher (default) priority than RAN Node 2.

At step 1, both of RAN Node 1 and RAN Node 2 initiate the shared N3 establishing with the same MBS parameters and requirements (see FIG. 8 for details). At step 2, each of RAN Node 1 and RAN Node 2 transmit a Xn message (e.g., MBS Session Context Transfer Request and Response) to each other.

At step 3a, RAN Node 2 receives the Xn message from RAN Node 1. Based on the default priority, RAN Node 2 stores the received Info from RAN Node 1 and releases the shared N3 tunnel that RAN Node 2 established. At step 4a, RAN Node 2 replies with a second Xn message (e.g., MBS Session Context Transfer Response) to the RAN Node 1. The message may contain one or more of the MBS Session Info, the Shared N3 Tunnel, or the Acknowledge indication

At step 3b, RAN Node 1 receives the Xn message from RAN Node 2. Based on the default priority, RAN Node 1 does not stores the received Info from RAN Node 2. RAN Node 1 replies with a second Xn message (e.g., MBS Session Context Transfer Response) to the RAN Node 2. The message may contain one or more of the MBS Session Info, the Shared N3 Tunnel, or the Failure Info. At step 4b, after RAN Node 1 receives all replied message (including RAN Node 2), RAN Node 1 becomes the Anchor Node of the shared N3 tunnel associated with the MBS Session in the Union RAN. RAN Node 1 stores the MBS Session Context and creates the lists associated with the MBS Session Context and the Shared N3 Tunnel. In some embodiments, the lists include a UE list and a RAN ID list. In some embodiments, the UE List is used to store which UE is currently using the MBS and shared N3 tunnel and camping in the RAN Node. In some embodiments, the RAN ID List is used to store the ID of the RAN Node which is using the MBS and the Shared N3 Tunnel.

In some embodiments, if RAN nodes other than RAN Node 1 and RAN Node 2 (e.g., RAN Node 3) receive an Xn message (e.g., MBS Session Context Transfer) from both RAN Node 1 and RAN Node 2 at the same time, RAN Node 3 only keeps the info that is transmitted from higher default priority RAN node and replies with an acknowledgement message. In some embodiments, RAN Node 3 replies with a failure message to lower priority RAN node.

In some embodiments, if RAN Node 3 receives Xn message (e.g., MBS Session Context Transfer) from RAN Node 1 first, RAN Node 3 records the received message. Then, in some embodiments, RAN Node 3 replies with an acknowledgement message to RAN Node 1 and replies with a failure message to RAN Node 2.

In some embodiments, if RAN Node 3 receives Xn message (e.g., MBS Session Context Transfer) from RAN Node 2 first and have already recorded the received info and replied RAN Node 2, RAN Node 3 uses the info received from RAN Node 1 to overwrite the related information. Then, in some embodiments, RAN Node 3 replies with an acknowledgement message to RAN Node 1.

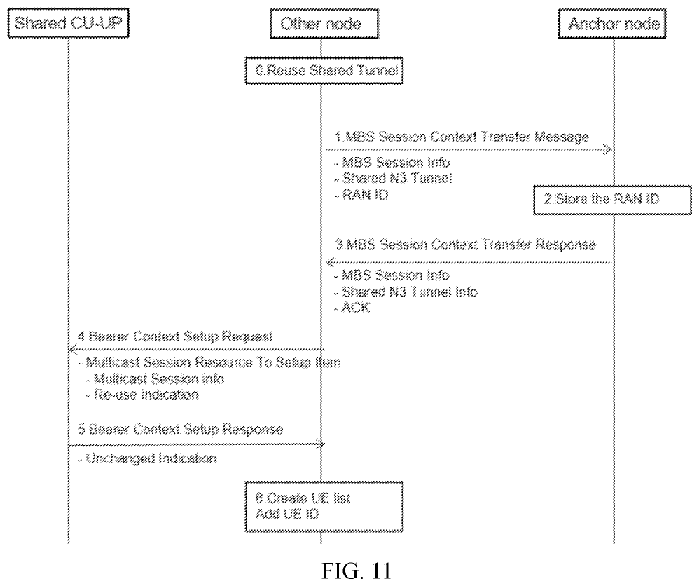

FIG. 11 illustrates a swim lane diagram for the Other Node re-using shared N3 Tunnel, in accordance with some embodiments. In some embodiments, the procedure of FIG. 11 is similar to the procedure of FIG. 7 except that in FIG. 7, the Other node does not detect an available tunnel for the MBS session in the Union RAN before, whereas in FIG. 11, the Other node detects an available tunnel for the MBS session. Before step 0, the Anchor Node has already established a shared N3 tunnel for this MBS Session. In some embodiments, the MBS Session Info and the Shared N3 Tunnel Info has been transformed from the Anchor Node to all of the other Nodes in the Union RAN. In some embodiments, the Other Node is not requested/required to re-use the shared N3 tunnel for this MBS. The Other Node can also send the common MBS Session Request Setup message to the 5GC and establish a new common Shared N3 tunnel if needed (e.g., area limitation for the current MBS.).

At step 0, Other Node decides to re-use the existing shared N3 tunnel instead of establishing a new shared N3 tunnel for the MBS Session. At step 1, Other Node transmits the Xn message MBS Session Context Transfer to Anchor Node. The message may contain one or more of the MBS Session Info, the Shared N3 Tunnel Info, the Other Node's RAN ID. At step 2, the Anchor Node receives the RAN ID from the Other Node and stores the received RAN ID into RAN ID List (created in step 5 of FIG. 4).

At step 3, the Anchor Node transmits the Xn message MBS Session Context Transfer Response to the Other Node. The message may contain one or more of the MBS Session Info, the Shared N3 Tunnel Info, or the ACK(indication). In some embodiments, additional steps (steps 4 and 5) are included, which are discussed with respect to FIG. 16. Step 4 and step 5 are not always required for some network structures. At step 6, the Other Node creates a UE List that is used to record which UE is using this shared N3 tunnel under this node and stores the UE ID that belongs to the UE which triggers this procedure into the UE List.

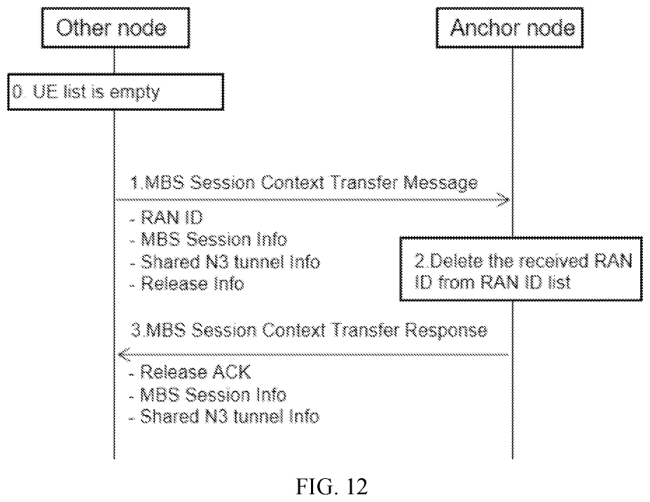

FIG. 12 illustrates a swim lane diagram for the Other Node releasing the shared N3 Tunnel, in accordance with some embodiments. At step 0, the UE List is empty. In some embodiments, no UE is using the shared N3 tunnel in this Other Node.

At step 1, the Other Node sends the Xn message (e.g., MBS Session Context Transfer Request) to the Anchor node. The message may contain one or more of the RAN ID (e.g., Other Node's RAN ID), the MBS Session Info, the Shared N3 Tunnel Info, or the Release Info. At step 2, the Anchor Node receives the message from the Other Node. In some embodiments, the Anchor Node deletes the received RAN ID from its RAN ID List.

At step 3, the Anchor Node replies with a second Xn message (e.g., MBS Session Context Transfer Response) to Other Node. In some embodiments, the message is used to notify/indicate to the Other Node that the RAN ID has been deleted from RAN ID List successfully. The message may contain one or more of the ACK(indication), the MBS Session Info, or the Shared N3 tunnel Info.

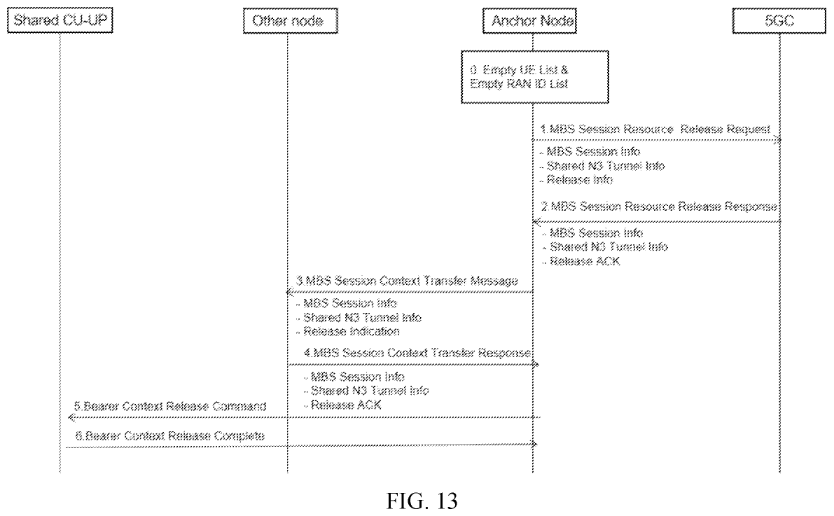

FIG. 13 illustrates a swim lane diagram for the Anchor Node releasing shared N3 Tunnel, in accordance with some embodiments. In some embodiments, the Anchor Node sends the message to 5GC and triggers the shared tunnel releasing only when both the UE List (e.g., used to record which UE is using the MBS and shared N3 tunnel in this RAN node) and the RAN ID List (e.g., used to record which Other Node is using the MBS and shared N3 tunnel in this Union RAN) are empty.

At step 0, if the leaving UE is not the last UE which is using the Shared N3 Tunnel associated with the MBS session, the Anchor Node deletes the UE ID from its UE List and ends the procedure. In some embodiments, if the Anchor Node recognizes that both UE List and RAN ID List are empty, the Anchor Node starts to release the related shared N3 Tunnel.

At step 1, the Anchor Node transmits a NG message which is used to release the shared N3 tunnel for this MBS. The message may contain one or more of the MBS Session Info, the Shared N3 Tunnel Info, or the Release Info. At step 2, the 5GC sends a NG message to the Anchor Node. The message may contain one or more of the MBS Session Info, the Shared N3 Tunnel Info, or the Release ACK.

At step 3, the Anchor Node transmits a Xn message (e.g., MBS Session Context Transfer) to all of the other Nodes in the Union RAN. The message may contain info which is used to notify the Other Nodes that the shared N3 tunnel is to be released. The message may contain one or more of the MBS Session Info, the Shared N3 Tunnel info, or a Release Indication. At step 4, the Other Node receives the message and releases the MBS Session Context, then replies with a second Xn message (e.g., MBS Session Context Transfer Response) that may include one or more of the MBS Session Info, the shared N3 tunnel info, or the Release ACK.

At step 5, the Anchor Node sends the E1 message Bearer Context Release Command to the Shared CU-UP. In some embodiments, this message is used to release the shared N3 tunnel at the Shared CU-UP side. At step 6, the Shared CU-UP releases the tunnel and replies with the E1 message Bearer Context Release Complete.

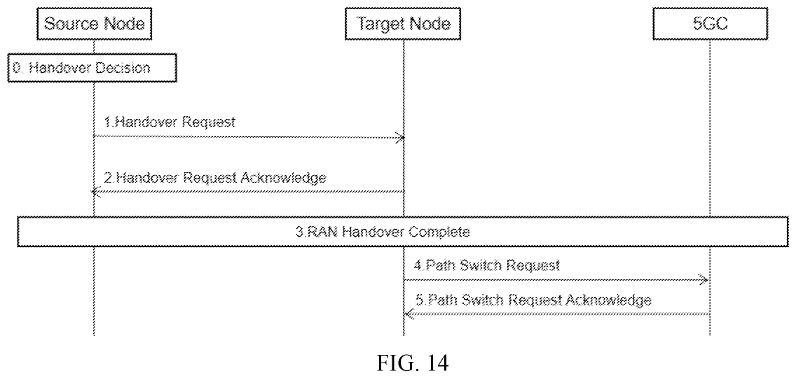

FIG. 14 illustrates a swim lane diagram for performing an Intra-Union RAN Handover, in accordance with some embodiments. In some embodiments, during the handover, target node can make the final decision about whether to establish/re-use the Shared N3 Tunnel in the Union RAN. In some embodiments, the target node can also use the common Shared N3 Tunnel for itself. In the example of FIG. 14, the target node decides to establish/re-use the Shared N3 Tunnel in the Union RAN.

At step 0, the Source Node makes the handover decision. At step 1, the Source RAN node sends a handover request message to Target RAN node. In some embodiments, the message at least contains at least one of the Shared N3 Tunnel info or the MBS Session Info. At step 2, the Target RAN sends a handover request ACK message to the Source RAN.

At step 3, after receiving ACK message from target RAN node (handover successful), the handover is completed. In some embodiments, at step 3a, if the UE is the last UE which is using the Shared N3 Tunnel for the MBS Session leaving the Source RAN node, then the Source RAN acts as in the procedure described in FIGS. 12 and 13. In some embodiments, at step 3.a.1, if the source node is the Anchor Node, the source node deletes the UE ID from its UE List (see FIG. 13 for details). In some embodiments, at step 3.a.2, if the source node is the Other Node, it deletes its UE List and notifies the Anchor Node to release its RAN ID (see FIG. 12 for details). In some embodiments, at step 3b, if the UE is not the last UE which is using the Shared N3 Tunnel for the MBS Session leaving the Source RAN node, the source node deletes the UE ID in the UE List (see FIGS. 12 and 13 for details).

In some embodiments, at step 3c, if the UE is the first UE which is using the Shared N3 Tunnel for the MBS Session joining the Target RAN and using the Shared N3 Tunnel for the MBS session, then the Target RAN node acts as in the procedure described in FIG. 11. In some embodiments, at step 3.c.1, if the target node is an Other Node, the target node adds the UE ID into its UE List and send its RAN ID to anchor node. The target node can also use common tunnel establishment procedure to setup a common shared N3 tunnel for itself. In some embodiments, at step 3d, if the UE is not the first UE which is using the Shared N3 Tunnel for the MBS Session joining the target RAN node, UE ID is added into the UE List.

At step 4, the Target RAN sends a Path Switch Request to the 5GC. In some embodiments, if the Target RAN node reuses the existing shared N3 tunnel, the shared N3 tunnel info and re-used indication is added into the path switch request message. At step 5, 5GC replies to the Path Switch Request by sending a Path Switch Acknowledge message to Target node.

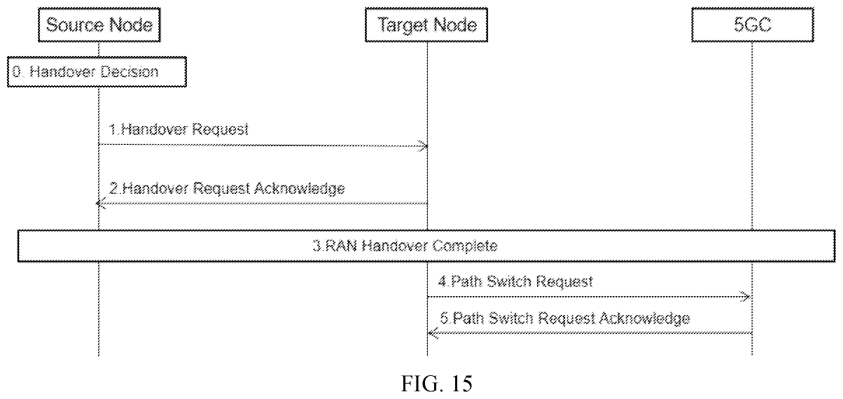

FIG. 15 illustrates a swim lane diagram for performing an Inter-Union RAN Handover, in accordance with some embodiments. In some embodiments, during the handover, target node can make the final decision about whether to establish/re-use the Shared N3 Tunnel in the Union RAN. In some embodiments, the target node can also use the common Shared N3 Tunnel for itself. In the example of FIG. 15, the target node decides to establish/re-use the Shared N3 Tunnel in the Union RAN.

At step 0, the Source Node makes the handover decision. At step 1, the Source RAN node sends a handover request message to Target RAN node. In some embodiments, the message at least contains at least one of the Shared N3 Tunnel info or the MBS Session Info. At step 2, the Target RAN sends a handover request ACK message to the Source RAN.

At step 3, after receiving ACK message from target RAN node (handover successful), the handover is completed. In some embodiments, at step 3a, if the UE is the last UE which is using the Shared N3 Tunnel associated with the MBS Session leaving the Source RAN node, then the Source RAN acts as in the procedure described in FIGS. 12 and 13. In some embodiments, at step 3.a.1, if the source node is the Anchor Node, the source node deletes the UE ID from its UE List (see FIG. 13 for details). In some embodiments, at step 3.a.2, if the source node is the Other Node, it deletes its UE List and notifies the Anchor Node to release its RAN ID (see FIG. 12 for details). In some embodiments, at step 3b, if the UE is not the last UE that is using the Shared N3 Tunnel for the MBS Session leaving the Source RAN node, the source node deletes the UE ID in the UE List (see FIGS. 12 and 13 for details).

In some embodiments, at step 3c, if the UE is the first UE that is using the Shared N3 Tunnel for the MBS Session joining the Target RAN, then, the next steps depend on whether the Target Node uses is a pre-configured Anchor Node mechanism or a contention-based Anchor Node mechanism. In some embodiments, at step 3.c.1, for the pre-configured Anchor Node mechanism, the Target RAN node acts as in one or more of the procedures described in FIGS. 4, 5, 6, 7, 9, or 11. In some embodiments, at 3.c.1.1, if the target node is an Anchor Node, it may start to establish the Shared N3 Tunnel for the MBS session and transmit the MBS Session Info to the Other Nodes in the union RAN (see FIGS. 4, 5, and 6 for details).

The Target Node may also establish a common Shared N3 Tunnel for the Target Node itself. In some embodiments, at step 3.c.1.2, if the target node is an Other Node, and it records the related MBS Session Info, the Target Node can add the UE ID into its UE List and send its RAN ID to Anchor Node (see FIGS. 7 and 11 for details). If there is no received tunnel info from Union RAN, the Target Node can transmit the received MBS message to the Anchor node for shared N3 tunnel establish. If the target node does not want to use the Union RAN's shared N3 tunnel, the Target Node can establish a new tunnel for itself by using common shared N3 tunnel establish procedure.

In some embodiments, at step 3.c.2, for the contention-based Anchor Node mechanism, the RAN node can start to establish a shared N3 tunnel for the MBS session (either for Union RAN or for itself) (see FIG. 9 for details). In some embodiments, at step 3d, if the UE is not the first UE that is using the Shared N3 Tunnel for the MBS Session joining the target RAN node, UE ID is added into the UE List.

At step 4, the Target RAN sends a Path Switch Request to the 5GC. In some embodiments, if the Target RAN node reuses the existing shared N3 tunnel, the shared N3 tunnel info and re-used indication is added into the path switch request message. At step 5, 5GC replies to the Path Switch Request by sending a Path Switch Acknowledge message to Target node.

FIG. 16 illustrates a swim lane diagram for performing E1AP Procedure for re-using Shared N3 Tunnel, in accordance with some embodiments. Some embodiments may be used for a configuration transmission between a shared CU-UP and a centralized unit control plane (CU-CP) (RAN Node) for re-using the existing shared N3 tunnel in the embodiments according to FIGS. 4-15.

At step 1, after the RAN node knows that it can re-use the existing shared N3 tunnel, the RAN Node transmits an E1 message (e.g., Bearer Context Setup Request) to the shared CU-UP in the Union RAN. The message may contain one or more of the MBS Session ID, the Tunnel ID, or a Re-use Indication.

At step 2, the Shared CU-UP receives the message and re-uses the existing shared N3 tunnel for the RAN Node. Then the Shared CU-UP replies with a second E1 message (e.g., Bearer Context Setup Response) to RAN Node. The message may contain one or more of the MBS Session ID, the Tunnel ID, or an Unchanged Indication.

FIG. 17 illustrates a method 1700 of establishing a tunnel, in accordance with some embodiments. Referring to FIGS. 1-16, the method 1700 can be performed by a wireless communication device (e.g., a UE) and/or a wireless communication node (e.g., base station, a gNB), in some embodiments. Additional, fewer, or different operations may be performed in the method 1700 depending on the embodiment.

At operation 1710, in some embodiments, a first one of a plurality of wireless communication nodes establishes a tunnel (e.g., an N3 tunnel) based on at least one of (i) whether a context of a Multicast and Broadcast Services (MBS) session is received, or (ii) one or more acknowledgement (ACK) messages corresponding to the context and the tunnel are received, the tunnel being shared by the plurality of wireless communication nodes for accessing a core network. In some embodiments, the plurality of wireless communication nodes share a same Centralized Unit-User Plane (CU-UP). In some embodiments, the first one of the plurality of wireless communication nodes is a RAN node, an NG-RAN node, a BS, a gNB, etc.

In some embodiments, the method 1700 is in accordance with a pre-configured or content-based mechanism. In a pre-configured mechanism, one of the plurality of wireless communication nodes is a certain Anchor node in the union RAN regardless of different MBS sessions. In a contention-based mechanism, for each MBS session or for same MBS session with different area scope, one of the plurality of wireless communication node can be an anchor node if (a) it starts the shared N3 tunnel establishment procedure, (b) it transmits the shared N3 tunnel info to all of the other related nodes in the union RAN (depending on whether it knows area of other nodes), or (c) it receives all reply info from related other nodes (depending on whether it knows area of other nodes).

In some aspects, the first wireless communication node is pre-configured as an anchor node, the method further includes storing, by the first wireless communication node, the context, and generating, by the first wireless communication node, a User Equipment (UE) list and an Random Access Node Identification (RAN ID) list associated with the context and the tunnel.

In some aspects, the method includes transmitting, by the first wireless communication node to one or more others of the plurality of wireless communication nodes, a first message includes at least one of the context, MBS Area information, or information corresponding to the tunnel. In some embodiments, the one or more other wireless communication nodes are located inside an area scope of the tunnel for the MBS session, and receiving, by the first wireless communication node from each of the one or more other wireless communication nodes, a second message including at least one of information corresponding to the MBS session, the information corresponding to the tunnel, or an acknowledgement indication.

In some aspects, the method includes transmitting, by the first wireless communication node to all of the others of the plurality of wireless communication nodes, a first message including at least one of the context, MBS Area information, or information corresponding to the tunnel, and receiving, by the first wireless communication node from at least a first one of the other wireless communication nodes, a second message including at least one of information corresponding to the MBS session, the information corresponding to the tunnel, or an acknowledgement indication. In some embodiments, the first other wireless communication node is located inside an area scope of the tunnel for the MBS session.

In some aspects, the method includes transmitting, by the first wireless communication node to all of the others of the plurality of wireless communication nodes, a first message including at least one of the context, MBS Area information, or information corresponding to the tunnel, and receiving, by the first wireless communication node from at least a second one of the other wireless communication nodes, a second message including at least one of information corresponding to the MBS session, the information corresponding to the tunnel, or an out-of-area scope indication. In some embodiments, the second other wireless communication node is located outside an area scope of the tunnel for the MBS session.

In some aspects, a second one of the plurality of wireless communication nodes is pre-configured as an anchor node, the method further includes transmitting, by the first wireless communication node to the second wireless communication node, a first message including at least one of information corresponding to the MBS session, area information, or an RAN ID of the first wireless communication node, and receiving, by the first wireless communication node from the second wireless communication node, a second message including the context, MBS Area information, information corresponding to the tunnel, or an acknowledgement indication.

In some aspects, the method includes generating, by the first wireless communication node, a UE list associated with the context and the tunnel, the UE list including an ID of a UE that is currently using the tunnel.

In some aspects, the first wireless communication node is not pre-configured as an anchor node, the method further includes transmitting, by the first wireless communication node to the core network, a first message including at least one of information corresponding to the MBS session or area information, and receiving, by the first wireless communication node from the core network, a second message including at least one of the information corresponding to the MBS session, the information corresponding to the tunnel, or MBS Area information.

In some aspects, the method includes transmitting, by the first wireless communication node to one or more others of the plurality of wireless communication nodes, a third message including at least one of the context, the MBS Area information, information corresponding to the tunnel, or an RAN ID of the first wireless communication node. In some embodiments, the one or more other wireless communication nodes satisfy an MBS area requirement, and receiving, by the first wireless communication node from each of the one or more other wireless communication nodes, a fourth message including at least one of information corresponding to the MBS session, the information corresponding to the tunnel, or an acknowledgement indication.

In some aspects, the method includes receiving, by the first wireless communication node from the one or more other wireless communication nodes, the one or more ACK messages, storing, by the first wireless communication node, the context, and generating, by the first wireless communication node, a UE list and an RAN ID list associated with the context and the tunnel.

In some aspects, the method includes transmitting, by the first wireless communication node to all of the others of the plurality of wireless communication nodes, a third message including at least one of the context, MBS Area information, information corresponding to the tunnel, or an RAN ID of the first wireless communication node, and receiving, by the first wireless communication node from at least a first one of the other wireless communication nodes, a fourth message including at least one of information corresponding to the MBS session, the information corresponding to the tunnel, or an acknowledgement indication. In some embodiments, the first other wireless communication node is located inside an area scope of the tunnel for the MBS session.

In some aspects, the method includes transmitting, by the first wireless communication node to all of the others of the plurality of wireless communication nodes, a third message including at least one of the context, MBS Area information, or information corresponding to the tunnel, or an RAN ID of the first wireless communication node, and receiving, by the first wireless communication node from at least a second one of the other wireless communication nodes, a fourth message including at least one of information corresponding to the MBS session, the information corresponding to the tunnel, or an out-of-area scope indication. In some embodiments, the second other wireless communication node is located outside an area scope of the tunnel for the MBS session.

In some aspects, the method includes receiving, by the first wireless communication node from the one or more other wireless communication nodes, the one or more ACK messages, storing, by the first wireless communication node, the context, and generating, by the first wireless communication node, a UE list and an RAN ID list associated with the context and the tunnel.

In some aspects, the first wireless communication node is not pre-configured as an anchor node but has initiated to establish the tunnel, the method further includes receiving, by the first wireless communication node from a second one of the plurality of wireless communication nodes, a first message including at least one of information corresponding to the MBS session, the information corresponding to the tunnel, or an acknowledgement indication. In some embodiments, the second wireless communication node has also initiated to establish the tunnel, and transmitting, by the first wireless communication node to the second wireless communication node, based on the first wireless communication node having a higher priority than the second wireless communication node, a second message including at least one of the information corresponding to the MBS session, the information corresponding to the tunnel, or failure information.

In some aspects, the method includes receiving, by the first wireless communication node from all of the others of the plurality of wireless communication nodes, the one or more ACK messages, storing, by the first wireless communication node, the context, and generating, by the first wireless communication node, a UE list and an RAN ID list associated with the context and the tunnel.

In some aspects, the method includes receiving, by the first wireless communication node from the other wireless communication nodes, a fifth message including at least one of the information corresponding to the MBS session, information corresponding to the tunnel, or RAN IDs of the other wireless communication nodes, storing, by the first wireless communication node, the RAN IDs into the RAN ID list, and transmitting, by the first wireless communication node to the other wireless communication nodes, a sixth message including at least one of the information corresponding to the MBS session, the information corresponding to the tunnel, or an acknowledgement indication.

In some aspects, the method includes in response to a first one of the other wireless communication nodes having an empty UE list, receiving, by the first wireless communication node from the first other wireless communication node, a fifth message including at least one of an RAN ID of the first other wireless communication node, the information corresponding to the MBS session, the information corresponding to the tunnel, or release information, deleting, by the first wireless communication node, the RAN ID of the first other wireless communication node from the RAN ID list, and transmitting, by the first wireless communication node to the first other wireless communication node, a sixth message including at least one of an acknowledgement indication, the information corresponding to the MBS session, or the information corresponding to the tunnel.

In some aspects, the method includes in response to determining that both of the RAN ID list and the UE list are empty, transmitting, by the first wireless communication node to all of the others of the plurality of wireless communication nodes, a fifth message including at least one of the information corresponding to the MBS session, the information corresponding to the tunnel, or a release indication, and receiving, by the first wireless communication node from all the other wireless communication nodes, a sixth message including at least one of the information corresponding to the MBS session or a release acknowledgement indication.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
establishing, by a first one of a plurality of wireless communication nodes, a tunnel based on at least one of: (i) whether a context of a Multicast and Broadcast Services (MBS) session is received: or (ii) one or more acknowledgement (ACK) messages corresponding to the context and the tunnel are received, the tunnel being shared by the plurality of wireless communication nodes for accessing a core network;
wherein the plurality of wireless communication nodes share a same Centralized Unit-User Plane (CU-UP).

2. The wireless communication method of claim 1, wherein the first wireless communication node is pre-configured as an anchor node, the method further comprises:
storing, by the first wireless communication node, the context; and
generating, by the first wireless communication node, a User Equipment (UE) list and an Random Access Node Identification (RAN ID) list associated with the context and the tunnel.

3. The wireless communication method of claim 2, further comprising:
transmitting, by the first wireless communication node to one or more others of the plurality of wireless communication nodes, a first message comprising at least one of: the context, MBS Area information, or information corresponding to the tunnel, wherein the one or more other wireless communication nodes are located inside an area scope of the tunnel for the MBS session; and
receiving, by the first wireless communication node from each of the one or more other wireless communication nodes, a second message comprising at least one of: information corresponding to the MBS session, the information corresponding to the tunnel, or an acknowledgement indication.

4. The wireless communication method of claim 2, further comprising:
transmitting, by the first wireless communication node to all of the others of the plurality of wireless communication nodes, a first message comprising at least one of: the context, MBS Area information, or information corresponding to the tunnel; and
receiving, by the first wireless communication node from at least a first one of the other wireless communication nodes, a second message comprising at least one of: information corresponding to the MBS session, the information corresponding to the tunnel, or an acknowledgement indication,
wherein the first other wireless communication node is located inside an area scope of the tunnel for the MBS session.

5. The wireless communication method of claim 2, further comprising:
transmitting, by the first wireless communication node to all of the others of the plurality of wireless communication nodes, a first message comprising at least one of: the context, MBS Area information, or information corresponding to the tunnel; and
receiving, by the first wireless communication node from at least a second one of the other wireless communication nodes, a second message comprising at least one of: information corresponding to the MBS session, the information corresponding to the tunnel, or an out-of-area scope indication,
wherein the second other wireless communication node is located outside an area scope of the tunnel for the MBS session.

6. The wireless communication method of claim 1, wherein a second one of the plurality of wireless communication nodes is pre-configured as an anchor node, the method further comprises:
transmitting, by the first wireless communication node to the second wireless communication node, a first message comprising at least one of: information corresponding to the MBS session, area information, or an RAN ID of the first wireless communication node; and
receiving, by the first wireless communication node from the second wireless communication node, a second message comprising: the context, MBS Area information, information corresponding to the tunnel, or an acknowledgement indication.

7. The wireless communication method of claim 6, further comprising:
generating, by the first wireless communication node, a UE list associated with the context and the tunnel, the UE list including an ID of a UE that is currently using the tunnel.

8. The wireless communication method of claim 1, wherein the first wireless communication node is not pre-configured as an anchor node, the method further comprises:
transmitting, by the first wireless communication node to the core network, a first message comprising at least one of: information corresponding to the MBS session or area information; and
receiving, by the first wireless communication node from the core network, a second message comprising at least one of: the information corresponding to the MBS session, the information corresponding to the tunnel, or MBS Area information.

9. The wireless communication method of claim 8, further comprising:
transmitting, by the first wireless communication node to one or more others of the plurality of wireless communication nodes, a third message comprising at least one of: the context, the MBS Area information, information corresponding to the tunnel, or an RAN ID of the first wireless communication node, wherein the one or more other wireless communication nodes satisfy an MBS area requirement; and
receiving, by the first wireless communication node from each of the one or more other wireless communication nodes, a fourth message comprising at least one of: information corresponding to the MBS session, the information corresponding to the tunnel, or an acknowledgement indication.

10. The wireless communication method of claim 9, further comprising:
receiving, by the first wireless communication node from the one or more other wireless communication nodes, the one or more ACK messages;
storing, by the first wireless communication node, the context; and
generating, by the first wireless communication node, a UE list and an RAN ID list associated with the context and the tunnel.

11. The wireless communication method of claim 8, further comprising:
transmitting, by the first wireless communication node to all of the others of the plurality of wireless communication nodes, a third message comprising at least one of: the context, MBS Area information, information corresponding to the tunnel, or an RAN ID of the first wireless communication node; and
receiving, by the first wireless communication node from at least a first one of the other wireless communication nodes, a fourth message comprising at least one of: information corresponding to the MBS session, the information corresponding to the tunnel, or an acknowledgement indication,
wherein the first other wireless communication node is located inside an area scope of the tunnel for the MBS session.

12. The wireless communication method of claim 8, further comprising:
transmitting, by the first wireless communication node to all of the others of the plurality of wireless communication nodes, a third message comprising at least one of: the context, MBS Area information, or information corresponding to the tunnel, or an RAN ID of the first wireless communication node; and
receiving, by the first wireless communication node from at least a second one of the other wireless communication nodes, a fourth message comprising at least one of: information corresponding to the MBS session, the information corresponding to the tunnel, or an out-of-area scope indication,
wherein the second other wireless communication node is located outside an area scope of the tunnel for the MBS session.

13. The wireless communication method of claim 11, further comprising:
receiving, by the first wireless communication node from the one or more other wireless communication nodes, the one or more ACK messages;
storing, by the first wireless communication node, the context; and
generating, by the first wireless communication node, a UE list and an RAN ID list associated with the context and the tunnel.

14. The wireless communication method of claim 1, wherein the first wireless communication node is not pre-configured as an anchor node but has initiated to establish the tunnel, the method further comprises:
receiving, by the first wireless communication node from a second one of the plurality of wireless communication nodes, a first message comprising at least one of: information corresponding to the MBS session, the information corresponding to the tunnel, or an acknowledgement indication, wherein the second wireless communication node has also initiated to establish the tunnel; and
transmitting, by the first wireless communication node to the second wireless communication node, based on the first wireless communication node having a higher priority than the second wireless communication node, a second message comprising at least one of: the information corresponding to the MBS session, the information corresponding to the tunnel, or failure information.

15. The wireless communication method of claim 14, further comprising:
receiving, by the first wireless communication node from all of the others of the plurality of wireless communication nodes, the one or more ACK messages;
storing, by the first wireless communication node, the context; and
generating, by the first wireless communication node, a UE list and an RAN ID list associated with the context and the tunnel.

16. The wireless communication method of claim 2, wherein the first wireless communication node has established the tunnel, and has transferred the information corresponding to the MBS session and the information corresponding to the tunnel to all of the others of the plurality of wireless communication nodes, the method further comprises:
receiving, by the first wireless communication node from the other wireless communication nodes, a fifth message comprising at least one of: the information corresponding to the MBS session, information corresponding to the tunnel, or RAN IDs of the other wireless communication nodes;
storing, by the first wireless communication node, the RAN IDs into the RAN ID list; and
transmitting, by the first wireless communication node to the other wireless communication nodes, a sixth message comprising at least one of: the information corresponding to the MBS session, the information corresponding to the tunnel, or an acknowledgement indication.

17. The wireless communication method of claim 2, wherein the first wireless communication node has established the tunnel, and has transferred the information corresponding to the MBS session and the information corresponding to the tunnel to all of the others of the plurality of wireless communication nodes, the method further comprises:
in response to a first one of the other wireless communication nodes having an empty UE list, receiving, by the first wireless communication node from the first other wireless communication node, a fifth message comprising at least one of: an RAN ID of the first other wireless communication node, the information corresponding to the MBS session, the information corresponding to the tunnel, or release information;
deleting, by the first wireless communication node, the RAN ID of the first other wireless communication node from the RAN ID list; and
transmitting, by the first wireless communication node to the first other wireless communication node, a sixth message comprising at least one of: an acknowledgement indication, the information corresponding to the MBS session, or the information corresponding to the tunnel.

18. The method of claim 2, wherein the first wireless communication node has established the tunnel, the method further comprises:
in response to determining that both of the RAN ID list and the UE list are empty, transmitting, by the first wireless communication node to all of the others of the plurality of wireless communication nodes, a fifth message comprising at least one of: the information corresponding to the MBS session, the information corresponding to the tunnel, or a release indication; and
receiving, by the first wireless communication node from all the other wireless communication nodes, a sixth message comprising at least one of: the information corresponding to the MBS session or a release acknowledgement indication.

19. A non-transitory computer readable storage medium storing instructions, which when executed by one or more processors can cause the one or more processors to:
establish, at a first one of a plurality of wireless communication nodes, a tunnel based on at least one of: (i) whether a context of a Multicast and Broadcast Services (MBS) session is received; or (ii) one or more acknowledgement (ACK) messages corresponding to the context and the tunnel are received, the tunnel being shared by the plurality of wireless communication nodes for accessing a core network;
wherein the plurality of wireless communication nodes share a same Centralized Unit-User Plane (CU-UP).

20. A wireless communication node, comprising:
at least one processor configured to:
establish a tunnel based on at least one of: (i) whether a context of a Multicast and Broadcast Services (MBS) session is received; or (ii) one or more acknowledgement (ACK) messages corresponding to the context and the tunnel are received, the tunnel being shared by a plurality of wireless communication nodes for accessing a core network;
wherein the plurality of wireless communication nodes share a same Centralized Unit-User Plane (CU-UP), and includes the wireless communication node.
